(19) United States
(12) Patent Application Publication
(10) Pub. No.: US 2026/0298265 A1
(43) Pub. Date: Oct. 1, 2026

(54) FLOW DEFLECTOR HAVING CHANNELS WITH DOUBLE EJECTION ANGLES

(71) Applicant: SAFRAN AIRCRAFT ENGINES, Paris (FR)

(72) Inventors: Valentin VERDON, MOISSY-CRAMAYEL (FR); Morgan BALLAND, MOISSY-CRAMAYEL (FR)

(73) Assignee: SAFRAN AIRCRAFT ENGINES, Paris (FR)

(21) Appl. No.: 19/137,610

(22) PCT Filed: Dec. 7, 2023
(86) PCT No.: PCT/FR2023/051950

§ 371 Date: Jun. 10, 2025

(30) Foreign Application Priority Data
Dec. 16, 2022 (FR) 2213562

(51) Int. Cl. F04D 29/54; F02K 3/075; F04D 19/00

(52) U.S. Cl. CPC F04D 29/541; F02K 3/075; F04D 19/00; F05D 2240/12; F05D 2250/314; F05D 2260/606

(57) ABSTRACT

A flow deflector is configured for a compressor of a ducted-fan turbine engine having a longitudinal axis. The flow deflector includes a wall provided with a plurality of ejection channels that discharge a discharge air flow into a flow path of the turbine engine. The ejection channels have an axis (C) and are arranged in multiple rows and are configured to eject the discharge air flow in the flow direction of the air flow . The axes (C) are oriented in a first direction forming a first angle (α) with respect to an axis (B) parallel to an axis of revolution of the discharge deflector. A projection of the axes of the ejection channels of each row in a projection plane (PP) perpendicular to the median plane (PM) forms a second angle (β) with a straight line parallel to the median plane.

### TECHNICAL FIELD OF THE INVENTION

This invention relates to the field of turbine engines, in particular dual-flow turbine engines for aircrafts. In particular, it is aimed at a flow deflector allowing for discharging a part of an air flow passing from a compressor into a flow path of the turbine engine. It also concerns a turbine engine comprising such a flow deflector.

### TECHNICAL BACKGROUND

Dual-flow turbine engines are known to be equipped with one or more air discharge systems for a compressor assembly. These systems are known as “Handling Bleed Valve” (HBV) or “Transient Bleed Valve” (TBV), which take a part of the primary flow from the high-pressure compressor, or “Variable Bleed Valve” (VBV), which takes a part of the primary flow from the low-pressure compressor. The taken air flows are ejected into the secondary flow or downstream of the primary flow. The purpose of this discharge is to stabilize the operation of the low-pressure compressor and/or the high-pressure compressor and to limit certain phenomena that may hamper their operation, such as pumping, rotating separation or floating.

The HBV type discharge system comprises a plurality of apertures leading into the secondary flow path where the secondary flow circulates. The jet of air flow ejected by the discharge system into the secondary flow path may impact the parts around the apertures, such as the internal wall partly delimiting the secondary flow path, referred to as IFD (Inner Fan Duct), or the external wall partly delimiting the secondary flow path, referred to as OFD (Outer Fan Duct), and possibly other parts in the wake of the air flow. The apertures may be oriented in the direction of the secondary flow or in a direction transverse to the air flow to increase the incorporation of the discharged primary flow into the secondary flow and to limit the thermal stresses on the neighboring structures and/or elements which are not configured to withstand high temperatures. An example of such a discharge system is described in the documents FR-A1-3057026, FR-A1-3057028 and U.S. Pat. No. 6,588,195 B2.

However, with this known discharge system, there is still a risk that certain parts around the ejection area of the air taken in the compressor may still be significantly impacted, particularly the OFD and the thrust reverser.

There is a need to resolve some or all of the above disadvantages.

### SUMMARY OF THE INVENTION

The aim of the present invention is to provide an air flow deflector that allows a better distribution of the air flow at its outlet while avoiding the thermal stresses and being economical and simple to manufacture.

This objective is achieved in accordance with the invention by means of a flow deflector for a discharge system of a compressor of a dual-flow turbine engine having a longitudinal axis, the flow deflector comprising a wall provided with a plurality of ejection channels capable of discharging a flow of discharge air flow from the compressor into a flow path of the turbine engine wherein an air flow circulates in a flow direction,
the ejection channels of axes being arranged in several rows in alignment directions substantially parallel to a median plane of the flow deflector which is substantially parallel to the flow direction and being configured so as to eject the discharge air flow in the direction of flow,
the axes each being oriented in a first direction forming a first angle relative to an axis parallel to an axis of revolution of the flow deflector,
the projection of the axes of the ejection channels of each row in a projection plane perpendicular to the median plane forming a second angle with a straight line parallel to the median plane.

Thus, this solution allows to achieve the above-mentioned objective. In particular, the orientation of each ejection channel at two angles, and in particular the second angle (axial and tangential orientation), allows to direct the jet of air flow exiting the deflector so as to rapidly homogenize the mixture and reduce the thermal impact on thermally sensitive parts without impacting the acoustics of the deflector. The arrangement of the second angle allows to reduce the temperature of the jet exiting the deflector, which provides greater protection for the walls, such as the radially internal and external walls delimiting the flow path of the turbine engine, and for the surrounding parts, such as a thrust reverser that may be carried by one of the walls of the flow path, and also to expand the flow of discharge air.

The deflector also comprises one or more of the following characteristics, taken alone or in combination:
the ejection channels in each row have a circular cross-section.
the values of the second angles are symmetrical with respect to the median plane.
the second angle increases from the median plane towards the edge of the deflector in a direction perpendicular to the median plane.
the variation in the second angle is progressive.
the second angle is constant in the same row on either side of the median plane.
the ejection channels are arranged so as to form curved lines parallel to each other, transverse with respect to the median plane and symmetrical with respect to the median plane.
the first angles of each row are constant.
each first angle in the same row varies in a decreasing manner between an upstream edge and a downstream edge of the wall in the direction of flow of the air flow.

The invention also relates to a turbine engine comprising at least one deflector having any of the preceding characteristics. The second angle considerably improves the protection of the structure of the turbine engine at the level of the radially external wall (OFD) when the deflector is mounted in the turbine engine.

The invention further relates to an aircraft comprising a turbine engine as mentioned above.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings wherein:

FIG. 1 shows a partial axial cross-section of an example of a turbine engine to which the invention applies;

FIG. 2 is a schematic view in axial cross-section of a flow path wherein an example of a discharge system according to the invention is positioned;

FIG. 3 shows a cross-sectional view of an example of a discharge system according to the invention;

FIG. 4 is a top view of the discharge system shown in FIG. 3.

### DETAILED DESCRIPTION OF THE INVENTION

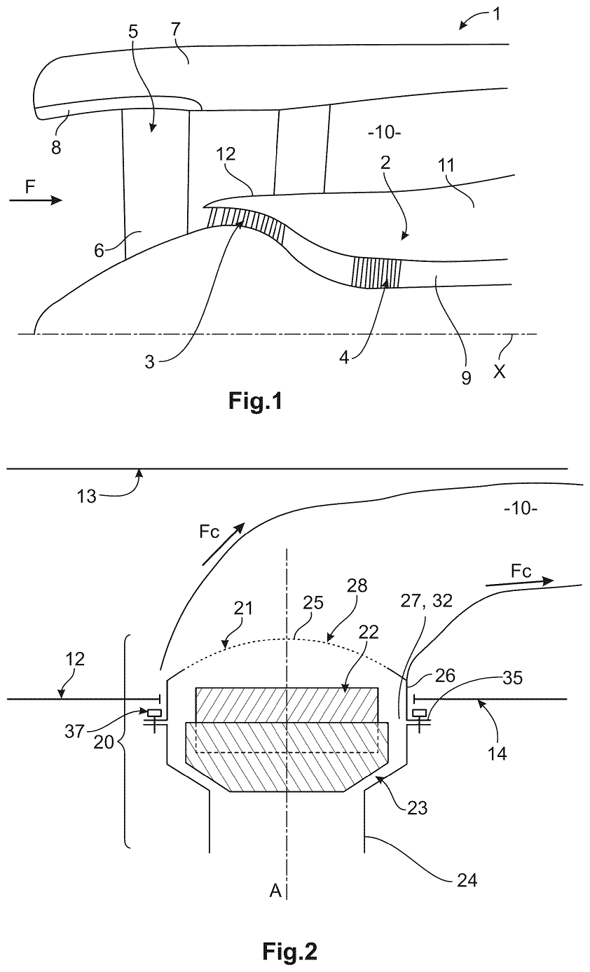

FIG. 1 shows schematically an aircraft turbine engine according to the invention. The turbine engine 1 shown is a turbofan engine with a double flow and a double body extending along a longitudinal axis X.

The turbine engine 1 generally comprises a gas generator 2. The latter generally comprises, from upstream to downstream, a low-pressure compressor 3, a high-pressure compressor 4, a combustion chamber (not shown), a low-pressure turbine (not shown) and a high-pressure turbine (not shown).

The terms “upstream” and “downstream” are defined in relation to the circulation of the gases in the turbine engine (in normal operating conditions) and along the longitudinal axis X. Similarly, the terms “radial”, “internal” and “external” are defined in relation to a radial axis Z perpendicular to the longitudinal axis X and in relation to the distance from the longitudinal axis X.

The low-pressure compressor 3 and the low-pressure turbine are connected by a low-pressure shaft (not shown) and together form a low-pressure (LP) body. The high-pressure compressor 4 and the high-pressure turbine are connected by a high-pressure shaft (not shown) and together form a high-pressure (HP) body. The low-pressure shaft and the high-pressure shaft are centered on the longitudinal axis.

The turbine engine comprises a fan 5 arranged upstream of the gas generator 2. The fan 5 is driven in rotation directly by the low-pressure shaft or via a speed reducer (not shown). The fan 5 comprises a row of fan vanes 6 extending radially outwards and evenly spaced around the longitudinal axis. The fan vanes 6 are surrounded by an external casing 7 which is supported by a fan casing 8. The external casing 7 is centered on the longitudinal axis X.

In one embodiment, the fan vanes 6 may be variable pitch.

With reference to FIG. 1, the turbine engine 1 comprises a first annular flow path, referred to as the primary flow path 9, wherein a primary flow (or hot flow) circulates, and a second annular flow path, referred to as the secondary flow path 10, wherein a secondary flow (or cold flow) circulates. The secondary flow path 10 advantageously surrounds the primary flow path 9. The primary flow path 9 and the secondary flow path 10 are separated by an annular inter-vein casing 11 located between the external casing 7 and an internal casing 11. The latter partially encloses the gas generator 2.

Advantageously, the primary flow path 9 is delimited by a radially internal wall of the inter-vein casing 11 and a radially external wall of an internal casing. This is coaxial with the inter-vein casing 11 and surrounded by the inter-vein casing 11. Advantageously, the secondary flow path 10 is delimited by a radially external wall 12 of the inter-vein casing 11 and a radially internal wall 13 of the external casing 7.

The primary flow passes through the compressors, the combustion chamber and the turbines, then discharges into the atmosphere through a nozzle (not shown).

With reference to FIG. 2, a discharge system 20 is arranged in the turbine engine so as to be able to take a part of an air flow at the level of one or more members of the turbine engine and to eject this part of the air flow into another air flow of the turbine engine.

Advantageously, the discharge system 20 is configured to take a portion of air from the high-pressure compressor 4. The portion of air taken is a portion of the primary flow.

The discharge system 20 is arranged between the primary flow path 9 and the secondary flow path 10. More specifically, the discharge system 20 is mounted on the radially external wall 12 of the inter-vein casing 11. Advantageously, but without limitation, the discharge system 20 is mounted in line with the high-pressure compressor 4 so as to reduce the overall dimensions. The portion of the primary flow is ejected into the secondary flow path 10.

In one example of embodiment, the discharge system 20 comprises at least one flow deflector 21 and a duct 24.

The flow deflector 21 comprises a wall 25 from which a peripheral skirt 26 extends. Advantageously, but not in a limiting manner, the wall 25 is circular and the peripheral skirt 26 is cylindrical with a circular cross-section of axis of revolution A. Of course, the shape of the wall 25 and the skirt 26 may be different, such as rectangular.

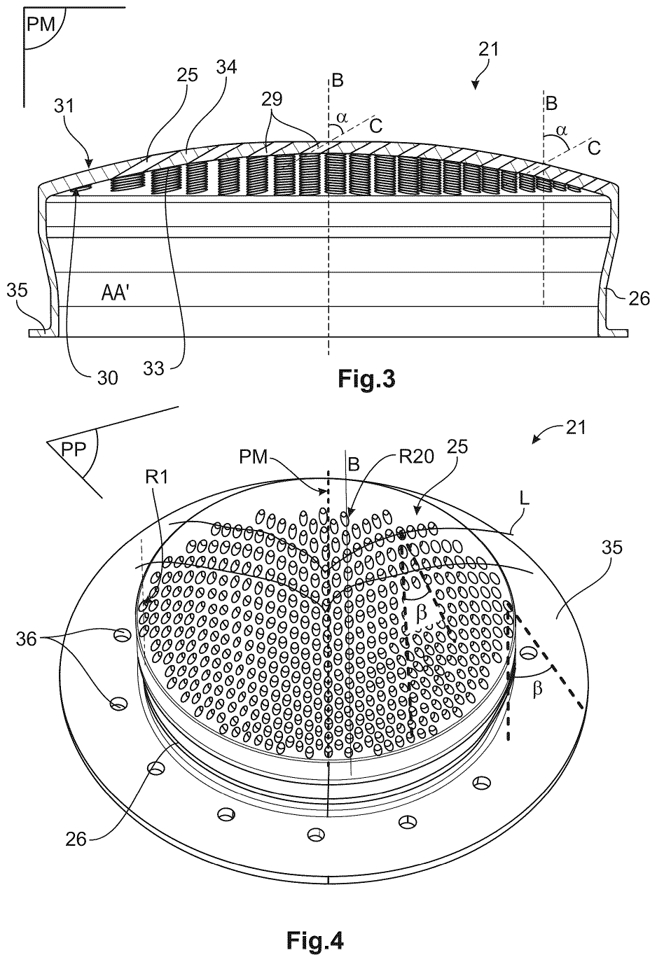

The deflector 21 comprises an air inlet 27 and an air outlet 28. Advantageously, the air inlet 27 is formed by a free rim of the peripheral skirt 26. The air outlet 28 is advantageously formed by ejection channels 29 (shown in particular in FIG. 3) arranged in the wall 25.

With reference to FIGS. 2 to 4, the flow deflector 21 comprises a collar 35 secured to the peripheral skirt 26. In this example, the collar 35 extends from the free end of the peripheral skirt 26 and surrounds the air inlet 27. The collar 35 allows the flow deflector 21 to be attached to the duct 24. The collar 35 comprises holes 36 passing through its wall on both sides. The holes 36 are configured to receive removable attachment means 37 such as screws.

According to the example shown in FIG. 2, the collar 35 is advantageously, but not exclusively, mounted opposite the radially internal surface 14 of the radially external wall 12 of the inter-vein casing 11.

Advantageously, the duct 24 is located in the inter-vein casing 11 (or in the core compartment of the turbine engine). The wall 25 and a portion of the peripheral skirt 26 are arranged in the secondary flow path 10 so that the primary flow received from the compressor via the air inlet is ejected directly into the secondary flow path 10 via the ejection channels 29. The peripheral skirt 26 defines an air flow passage between the air inlet 27 and the ejection channels 29.

The duct 24 comprises an air inlet (not shown) configured to be in fluidic communication with the primary flow path 9 and to receive a part of the primary flow from the high-pressure compressor 4. The duct 24 also comprises an air outlet 32 coupled to the air inlet 27 of the flow deflector 21. The duct 24 allows the passage of the flow of hot air from the compressor towards the flow deflector 21.

A regulating device 22 and an actuator 23 may be located in the duct 24, or upstream of the duct 24 in the vicinity of the primary flow path 9.

In FIGS. 3 and 4, the wall 25 is provided with a plurality of ejection channels 29 capable of discharging a portion of the primary air flow into the secondary flow path 10 where the secondary air flow circulates. The ejection channels 29 are configured so as to eject a discharge air flow Fc which does not come into direct contact with the walls 12 (IFD), 13 (OFD) of the secondary flow path 10 and which does not disturb the flow or circulation of the secondary flow.

The wall 25 of the deflector is arched or dome shaped. The wall 25 has a substantially constant thickness of between 1 and 5 mm. In particular, the wall 25 has a concave internal surface 30 facing the regulating device 22 of the discharge system 20 and a convex external surface 31 opposite the internal surface 30. In this example, the latter faces the secondary flow path 10. In this case, the wall 25 has a circular peripheral edge, as described above.

With reference to FIG. 3, the ejection channels 29 are formed in the wall 25 of the deflector 21. Each ejection channel 29 extends on either side between the internal surface 30 and the external surface 31. In the examples shown, the ejection channels 29 occupy almost the entire surface of the wall 25. Each ejection channel 29 has an inlet orifice 33 defined in the internal surface 30 and communicating fluidly with the passage of the deflector 21. Each ejection channel 29 comprises an outlet orifice 34 defined in the external surface 31 and communicating fluidly with the secondary flow path 10.

The ejection channels 29 have a substantially constant circular cross-section. Of course, the cross-section of the channels 29 may be any other shape. Here, the channels 29 have a diameter of between 2 and 3 mm (preferably of the order of 2.5 mm) so as to facilitate the manufacture of the flow deflector, adapt the flow rate of the discharge flow to be discharged and limit noise pollution. The length of these channels 29 is preferably between 1 mm and 6 mm. The size of the channels 29 will depend on the dimensions of the deflector (in particular the thickness of the wall) and the flow rate of discharge flow to be discharged into the secondary flow path 10.

The ejection channels 29 are arranged in several rows R1, R20, etc. Each row R1, R20 extends in an alignment direction (B) parallel or substantially parallel (by plus or minus 5°) to a median plane PM of the flow deflector 21. In other words, the rows are parallel to each other. The median plane PM is parallel to the direction of flow of the air flow (in this case the secondary flow in the installation situation). The median plane PM is in the plane shown in FIG. 3 and comprises the axis of revolution A of the deflector 21.

Advantageously, the rows R1, R20 each form a discharge flow blade.

Each row R1, R20 comprises between 1 and 30 ejection channels 29. The channels 29 are spaced from one another by a distance of between 0.5 and 3 mm, for example, to maintain the mechanical strength of the wall 25 of the flow deflector. It is understood that the number of rows and the number of ejection channels 29 per row depends, on the one hand, on the dimensions of the flow deflector 21 and the ejection channels 29 and, on the other hand, on the desired flow rate through the deflector 21 when the valve is open.

As also illustrated in FIGS. 3 and 4, the ejection channels 29 are arranged so as to form lines L parallel to each other. The lines L are advantageously arranged transversely to the median plane PM. In particular, the lines L are oriented towards the lateral edges of the deflector 21. The lateral edges are arranged on either side of the median plane PM.

In this example of embodiment, the lines L are curved. The rounded shape of the lines L is accentuated by the spherical shape of the wall 25.

Another advantageous but non-limiting characteristic is that the lines L are symmetrical with respect to the median plane. These are substantially V-shaped, with the tip of the V lying on the median plane PM.

The channels 29 are configured so as to discharge the air jet in the direction of flow of the secondary air flow.

Each ejection channel 29 has a central axis C. In the present example, the central axis C of each ejection channel 29 is oriented in a direction forming a first angle α defined with respect to an axis B parallel to the axis of revolution A of the deflector. In this example, the axis B is vertical in the plane shown in FIG. 3. Each first angle α is measured in a vertical plane parallel to the median plane PM or to the longitudinal axis X (when installed in the turbine engine).

Advantageously, each first angle α is between 0° and 90°. This ensures that the flow of primary air leaving the deflector 21 avoids the radially internal and external walls 12, 13 of the secondary flow path 10.

Advantageously, the first angles α of each row decrease from upstream to downstream along the direction of flow (or the longitudinal axis X when the discharge system 21 is installed in the turbine engine). In other words, the ejection channels 29 in the same row are oriented at a first angle α which decreases between a first channel in a row and the last channel in that row. The first angles α are then different. This variation is defined between an upstream edge and a downstream edge of the wall.

An advantageous but non-limiting characteristic is that the variation is gradual so as not to disturb the secondary flow. In this way, the discharge air flow blades Fc passing through the ejection channels 29 are guided in a direction oriented in the direction of circulation of the secondary flow.

In one embodiment, the ejection channels 29 in each row are oriented at the same angle α so as to form a discharge air flow blade Fc. In other words, the ejection channels 29 in the same row are oriented at an identical angle α. This configuration prevents the discharge flow blade Fc from coming into contact with the radially internal wall 13 and/or a thrust reverser that comprises the turbine engine.

According to an example of embodiment and such as shown in FIG. 4, the projection of the axes C of the ejection channels 29 of each row in a projection plane PP perpendicular to the median plane PM forms a second angle β with a straight line parallel to the median plane. This configuration maximizes the frontal mixing surface between the flow jet exiting the deflector and the secondary flow so as to improve the mixing.

Advantageously, the second angles β of each row are constant. A row has one and the same angle on each side of the median plane. Alternatively, the second angles β of each row are not constant.

An advantageous characteristic is that the second angles β increase from the median plane PM towards the lateral edge opposite the median plane. The direction of this increasing variation is perpendicular to the median plane PM. In other words, the second angles β vary in the same curved line towards the edge of the wall 25. Between an ejection channel in one row and an ejection channel in an adjacent row, the second angle β increases from the median plane. This configuration allows a better distribution of the discharge air flow in the flow of the air flow.

As may be seen in FIG. 4 and in a non-limiting manner, the curved lines L, which are symmetrical on either side, form a V shape with the tip of the V passing through the median plane. This accentuates the tangential component of the channels and favors the distribution of the discharge air flow towards the edges of the deflector.

Advantageously, the variation in the second angle β is progressive, for example, to improve the distribution of the hot jet.

The values of the second angles β are symmetrical with respect to the median plane PM. This allows to ensure that the flow is evenly distributed. This distribution may be non-symmetrical.

The second angle β is between 0° and 90° inclusive. The amplitude of the variation in the second angle β may be defined according to the need to dilute the discharge air flow in the secondary flow. The greater the variation in the second angle, the greater the dilution. An amplitude of variation of +/−30° between the median plane and the row furthest from the median plane, on either side of the median plane, may nevertheless provide a sufficient dilution in certain configurations.

Thus, when the discharge air flow Fc is ejected into the secondary flow path 10, it is directed along several blades with a substantially parabolic shape which avoids the thermal shocks with the environment of the discharge system 20. The circulation and the flow of the cold air flow F is not disturbed. The second angles β allow a better distribution of the flux in an azimuthal (or tangential) direction of the grid.

1. A flow deflector for a discharge system of a compressor of a dual-flow turbine engine having a longitudinal axis (X), the flow deflector comprising a wall provided with a plurality of ejection channels configured to discharge a discharge air flow from the compressor into a flow path of the turbine engine, wherein an air flow circulates in a flow direction, ejection channels of axes (C) being arranged in several rows (R1, R20) in alignment directions (B) substantially parallel to a median plane (PM) of the flow deflector which is parallel to the flow direction and is configured to eject the discharge air flow in the flow direction, the axes (C) each being oriented in a first direction forming a first angle (α) with respect to an axis (B) parallel to an axis of revolution of the flow deflector, wherein a projection of the axes of the ejection channels of each row in a projection plane (PP) perpendicular to the median plane (PM) forms a second angle (β) with a straight line parallel to the median plane (PM), and the second angle (β) increases from the median plane (PM) towards an edge of the deflector in a direction perpendicular to the median plane (PM).

2. The deflector according to claim 1, wherein the ejection channels in each row have a circular cross-section.

3. The deflector according to claim 1, wherein values of the second angles (β) are symmetrical with respect to the median plane.

4. The deflector according to claim 1, wherein variation in the second angle (β) is progressive.

5. The deflector according to claim 1, wherein the second angle (β) is constant in the same row on either side of the median plane.

6. The deflector according to claim 1, wherein the ejection channels are arranged to form curved lines (L) parallel to each other, transverse with respect to the median plane (PM) and symmetrical with respect to the median plane (PM).

7. The deflector according to claim 1, wherein first angles (α) of each row are constant.

8. The deflector according to claim 1, wherein each first angle (α) of the same row varies in a decreasing manner between an upstream edge and a downstream edge of the wall according to the direction of flow of the air flow (F).

9. The deflector according to claim 1, wherein the second angle (β) is between 0° inclusive and 90° inclusive.

10. A dual-flow turbine engine comprising at least one deflector according to claim 1.
